(19) United States
(12) Patent Application Publication
(10) Pub. No.: US 2022/0083942 A1
(43) Pub. Date: Mar. 17, 2022

(54) INFORMATION PROCESSING DEVICE, INFORMATION PROCESSING SYSTEM, AND NON-TRANSITORY STORAGE MEDIUM

(71) Applicant: TOYOTA JIDOSHA KABUSHIKI KAISHA, Toyota-shi (JP)

(72) Inventors: Takaharu UENO, Nagoya-shi (JP); Kenichi YAMADA, Nisshin-shi (JP); Ryosuke KOBAYASHI, Nagakute-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 17/471,855

(22) Filed: Sep. 10, 2021

(30) Foreign Application Priority Data
Sep. 16, 2020 (JP) 2020-155244

(51) Int. Cl. G06Q 10/06; G07C 5/00; G06Q 30/02; B60W 40/08; B60W 40/02; B60W 40/12

(52) U.S. Cl. CPC G06Q 10/06313; G07C 5/008; G06Q 30/0201; G06Q 50/26; B60W 40/02; B60W 40/12; B60W 40/08

(57) ABSTRACT

An information processing device, comprises a controller configured to execute: estimating an action being done by a user, based on first data about the action of the user; obtaining second data about a travel environment of the user; and deciding whether to dispatch a vehicle to the user, based on the estimated action and the second data.

### CROSS REFERENCE TO THE RELATED APPLICATION

This application claims the benefit of Japanese Patent Application No. 2020-155244, filed on Sep. 16, 2020, which is hereby incorporated by reference herein in its entirety.

### BACKGROUND

### Technical Field

The present disclosure relates to a technique for supporting travel of a user.

### Description of the Related Art

A service of supporting travel of a user by dispatching an autonomous vehicle to the user is expected to be realized in the future.

For example, Japanese Patent Laid-Open No. 2019-101464 has disclosed a system in which a time when a user will arrive at a vehicle allocation location is predicted and an autonomous vehicle is arranged in time for the predicted time.

### SUMMARY

In some cases, demand for vehicles abruptly increases due to the operation status of public transportations or changes in other travel environments. In such a case, a vehicle may not be able to be dispatched regardless of being requested.

It is an object of the present disclosure to provide a technique for autonomously dispatching a vehicle to a user as required.

The present disclosure in its one aspect provides an information processing device, comprising: a controller configured to execute: estimating an action being done by a user, based on first data about the action of the user; obtaining second data about a travel environment of the user; and deciding whether to dispatch a vehicle to the user, based on the estimated action and the second data.

The present disclosure in its another aspect provides an information processing system, comprising: a first device held by a user; and a second device associated with a vehicle; wherein the first device includes a first controller configured to transmit first data to the second device, the first data being about an action of the user; and the second device includes a second controller configured to execute: estimating an action being done by the user, based on the first data; obtaining second data about a travel environment of the user; and deciding whether to dispatch the vehicle to the user, based on the estimated action and the second data.

The present disclosure in its another aspect provides a non-transitory computer readable storing medium recording a computer program for causing a computer to perform an information processing method comprising: estimating an action being done by a user, based on first data about the action of the user; obtaining second data about a travel environment of the user; and deciding whether to dispatch a vehicle to the user, based on the estimated action and the second data.

In addition, other aspects include an information processing method executed by the above information processing device and a computer readable storage medium storing the above program in a non-transitory manner.

According to the present disclosure, a vehicle can be autonomously dispatched to a user as required.

### BRIEF DESCRIPTION OF THE DRAWINGS

FIG. 1 is a diagram for describing an overview of a vehicle allocation system;

FIG. 2 is a diagram illustrating, in more detail, components of the vehicle allocation system;

FIG. 3 is an example of positional information data that is stored in a storage unit;

FIG. 4 is an example of a travel route associated with a go-home action;

FIG. 5 is an example of vehicle data that is stored in the storage unit;

FIG. 6 is diagram of data flow between function modules that are included in a control unit;

FIG. 7 is a flowchart of processing that is performed by the control unit in a first embodiment;

FIG. 8 is a flowchart of processing that is performed by the control unit in a second embodiment; and

FIG. 9 is a diagram for describing a vehicle allocation location in the second embodiment.

### DESCRIPTION OF THE EMBODIMENTS

In the near future, a system for supporting travel of a user by an autonomous vehicle which is operated on-demand is expected to be realized.

In such a system, there may occur a problem of concentration of demands. For example, in a case where weather has got worse or a railroad operation has stopped, demands for vehicles will abruptly increase and if a user desires to travel by vehicle, a system side may not be able to respond to it.

An information processing device according to an embodiment responds to such a case by estimating in advance that a user will need a vehicle and autonomously deciding whether to dispatch a vehicle to the user, based on the action and travel environment of the user.

The information processing device according to the embodiment includes a control unit that performs: estimating an action being done by a user based on first data about the action of the user; obtaining second data about a travel environment of the user; and deciding whether to dispatch a vehicle to the user, based on the estimated action and the second data.

The first data may be any data as long as it is about an action being done by the user. For example, the first data may be positional information corresponding to the user. Based on the first data, it can be estimated, for example, that the user is going back home.

The second data is data about the travel environment of the user. The second data may be, for example, data for predicting that travel of the user will become difficult. Examples of such data include data about the weather (for example, distribution of rain clouds) and data about the operation of public transportation (for example, information about disruptions in the time schedule); however, they are not limited thereto.

The control unit determines whether the user needs a vehicle (or will need it later) based on the estimated user's action and the second data; and decides whether to dispatch a vehicle. This configuration allows a vehicle to be arranged before the user indicates such an intention.

In addition, the first data may include positional information corresponding to the user.

The positional information may be obtained by, for example, a terminal (for example, a smart phone) held by the user.

In addition, the control unit may estimate an action being done by the user, based on changes in the positional information which is periodically obtained.

For example, in a case where the user is traveling toward home, it can be estimated that the user is doing an action for going home.

In addition, the control unit may periodically obtain vehicle information that is information about the vehicle and further determine whether the vehicle can be dispatched based on the vehicle information.

The vehicle information may be, for example, data including a current position of the vehicle, an operation state, and an allowable traveling distance. When a plurality of vehicles are included in the system, vehicle information of each of them is referred to, thereby allowing a vehicle that can be dispatched to be decided.

When it is estimated that the user is doing the action of going home, the control unit may estimate a first time at which the user will arrive at a station nearest to the home of the user, based on the first data.

In addition, the control unit may cause the vehicle to arrive at the nearest station by the first time.

When the user is doing an action for going home, setting a station of public transportation as a vehicle allocation destination allows a last one mile transport. In addition, estimating the first time allows a wait time of the user at the station to be minimized. The first time can be estimated based on a railroad operation schedule, for example.

In addition, the second data may be data about the weather.

For example, when a bad weather at the time of arrival of the user at a station is predicted, it may be decided to dispatch a vehicle to the station. Data about the weather can be obtained by using an external service, for example.

In addition, the second data may be data about the amount of baggage associated with the user.

For example, when the user is carrying a large amount of baggage, it is preferable to dispatch a vehicle. The amount of baggage the user is carrying may be determined, for example, based on an image obtained by imaging the user, or may be determined based on a history of payments made by the user.

In addition, the control unit may determine a location where travel of the user will become difficult based on the second data, and dispatch the vehicle to the location.

In addition, the second data may be data about the operation of public transportation.

For example, when it is detected, based on information obtained from a device that provides railroad operation information, that train operation is interrupted or the operation of a line to be transferred to is being stopped, a relevant station can be determined as “a location where travel becomes difficult.” This configuration allows a user who has lost travel means to be helped.

In addition, the information processing device further may include a storage unit that stores data indicating a typical action pattern of the user; and the control unit may estimate the action based on a result of comparison between the first data and the action pattern.

For example, when the first data is positional information, a plurality of pieces of positional information which are periodically obtained and a collection of positional information corresponding to the action pattern are compared with each other, thereby enabling determination that the action of the user matches with the action pattern of “going home.”

In addition, the information processing device further may include a storage unit that stores data indicating a typical action pattern of each of a plurality of users; and the control unit may estimate the action of any of the plurality of users, based on a result of comparison between the first data and the action patterns of the plurality of users.

By holding action patterns of a plurality of users, a service can be provided to the plurality of users.

Hereinafter, embodiments of the present disclosure will be described with reference to drawings. Configurations of the embodiments below are illustrative and the present disclosure is not limited to the configurations of the embodiments.

### First Embodiment

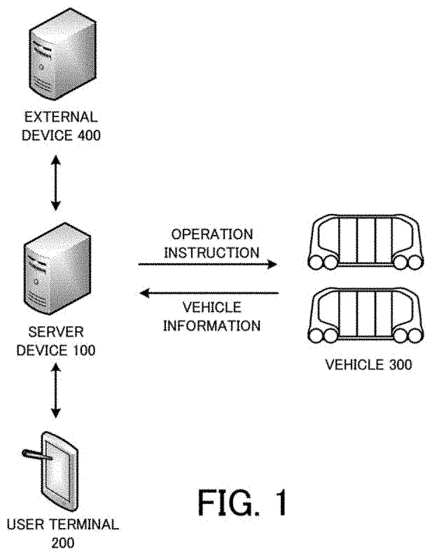

An overview of a vehicle allocation system according to a first embodiment will be described with reference to FIG. 1. The vehicle allocation system according to this embodiment includes: a user terminal 200 carried by a user; an autonomous vehicle 300 (hereinafter, a vehicle 300) that provides a transport service; a server device 100 that controls the vehicle 300; and an external device 400 that provides information to the server device 100.

The user terminal 200 is a mobile terminal carried by the user. The user terminal 200 periodically transmits information about the action of the user to the server device 100. In this embodiment, the user terminal 200 transmits positional information of its own terminal as information about the action of the user.

The vehicle 300 is an autonomous vehicle that provides a transport service to the user. The vehicle 300 can perform unmanned travel according to an instruction transmitted from the server device 100. In addition, the vehicle 300 allows the user to get on and off thereof on the way of a route. The system may include a plurality of vehicles 300.

The external device 400 is a server device that provides information about a travel environment of the user (hereinafter, environment information). Examples of the information about the travel environment include meteorological information (weather, temperature, humidity, etc.); however, they are not limited thereto.

It should be noted that although one external device 400 is illustrated in FIG. 1, the server device 100 may obtain each different kind of environment information from each of a plurality of external devices 400.

The server device 100 is a device that controls travel of the vehicle 300. In addition, the server device 100 estimates that the user needs a vehicle (or will need it later) based on the positional information received from the user terminal 200 and the environment information received from the external device 400; and based on a result of the estimation, dispatches the vehicle 300 to the user. Thus, transportation means can be autonomously provided to the user who needs means of travel.

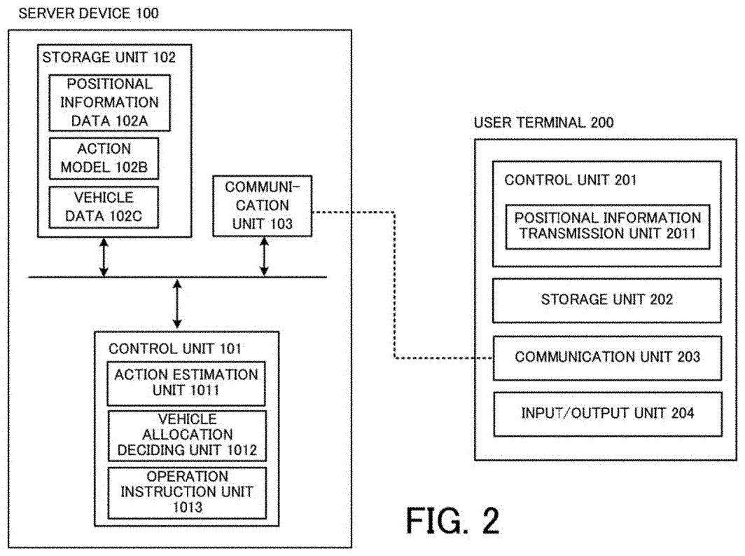

FIG. 2 is a diagram illustrating, in more detail, components of the vehicle allocation system according to this embodiment.

First, the user terminal 200 will be described.

The user terminal 200 is a small computer such as, for example, a smart phone, a cellular phone, a tablet computer, a personal information terminal, a notebook computer, or a wearable computer (such as smart watch). The user terminal 200 includes a control unit 201, a storage unit 202, a communication unit 203, and an input/output unit 204.

The control unit 201 is an arithmetic unit that manages control performed by the user terminal 200. The control unit 201 can be implemented by an arithmetic processing unit such as a central processing unit (CPU).

The control unit 201 is configured with a function module of a positional information transmission unit 2011. The function module may be implemented by the CPU executing a program which is stored in the storage unit 202 described later.

The positional information transmission unit 2011 obtains positional information of its own terminal and periodically transmits it to the server device 100. The positional information can be, for example, generated based on a result of positioning by a GPS. The positional information transmission unit 2011 may include a module that receives a positioning signal transmitted from a GPS satellite and outputs positional information of the terminal.

The storage unit 202 includes main memory and auxiliary memory. The main memory is a memory where a program executed by the control unit 201 and data used by the control program are expanded. The auxiliary memory is a device where a program executed by the control unit 201 and data used by the control program are stored. The auxiliary memory may store the program executed by the control unit 201, which has been packaged as an application. In addition, it may store an operating system for executing such an application. The program stored in the auxiliary memory is loaded to the main memory and executed by the control unit 201, thereby causing processing described later to be performed.

The main memory may include a random access memory (RAM) and a read only memory (ROM). The auxiliary memory may include an erasable programmable ROM (EPROM) and a hard disk drive (HDD). In addition, the auxiliary memory may include removable media, that is, a removable recording medium. Examples of removable media include a universal serial bus (USB) memory and disk recording media such as a compact disc (CD) and a digital versatile disc (DVD).

The communication unit 203 is a wireless communication interface for connecting the user terminal 200 to a network. The communication unit 203 is configured to be communicable with the server device 100 via, for example, a wireless LAN, 3G, LTE, or 5G mobile communication service.

The input/output unit 204 is a unit that accepts an input operation performed by a user and presents information to the user. In this embodiment, it consists of one touch panel display. More specifically, it is composed of a liquid crystal display and a control unit thereof, and a touch panel and a control unit thereof.

Next, the server device 100 will be described.

The server device 100 stores a model representing a typical action that can be done by the user (hereinafter, an action model); and determines, based on positional information received from the user terminal 200, that the user carrying the user terminal 200 is doing an action for going home (hereinafter, a go-home action).

In addition, when the user starts the go-home action, the server device 100 obtains information from the external device 400 and predicts, based on the information, whether the user will need a vehicle. When determining that the user will need a vehicle, it makes arrangements for the vehicle 300.

The server device 100 can be comprised of a general-purpose computer. More specifically, the server device 100 can be configured as a computer that includes a processor such as a CPU or a GPU, main memory such as RAM and ROM, and auxiliary memory such as an EPROM, a hard disk drive, removable media, and the like. Examples of the removable media may include a USB memory and disk recording media such as CD and DVD. In the auxiliary memory, an operating system (OS), various programs, various tables, and the like are stored, and programs stored therein are loaded into a work area of the main memory and are executed. Through the execution of the programs, each component and the like are controlled and thereby, each function corresponding to a predetermined purpose as described later can be implemented. However, part or all of the functions may be implemented by a hardware circuit such as an ASIC or FPGA.

A control unit 101 is an arithmetic unit that manages control performed by the server device 100. The control unit 101 can be implemented by an arithmetic processing unit such as a CPU.

The control unit 101 is configured with three function modules of an action estimation unit 1011, a vehicle allocation deciding unit 1012, and an operation instruction unit 1013. Each of the function modules may be implemented by the CPU executing a stored program.

The action estimation unit 1011 obtains positional information from the user terminal 200 and estimates, based on the obtained positional information, that the user has started the go-home action. This estimation can be performed by using an action model stored in a storage unit 102 described later.

The vehicle allocation deciding unit 1012 decides whether the vehicle 300 is necessary for the user, based on the information obtained from the external device 400.

When the user is doing the go-home action and it is determined that a vehicle is necessary for the user, the vehicle allocation deciding unit 1012 generates a plan for making the vehicle 300 operate (for example, a location to which the vehicle is sent and an arrival time) and transmits it to the operation instruction unit 1013.

The operation instruction unit 1013, on the basis of the plan received from the vehicle allocation deciding unit 1012, decides the vehicle 300 to be dispatched to the user and generates an instruction for transporting the user (operation instruction).

In addition, the operation instruction unit 1013 includes a function of managing the vehicles 300 included in the system. The operation instruction unit 1013 periodically communicates with the plurality of vehicles 300 included in the system, thereby obtaining the current position and state, currently executed task, occupied time, and the like of each vehicle; and stores these data as vehicle data. By referring to the stored vehicle data, a vehicle to be dispatched to a specific user can be decided.

It should be noted that when the system includes one vehicle 300 (such as when the vehicle 300 is a user-owned vehicle), a function of managing the vehicle 300 may be omitted.

The storage unit 102 includes main memory and auxiliary memory. The main memory is a memory where a program executed by the control unit 101 and data used by the control program are expanded. The auxiliary memory is a device where a program executed by the control unit 101 and data used by the control program are stored.

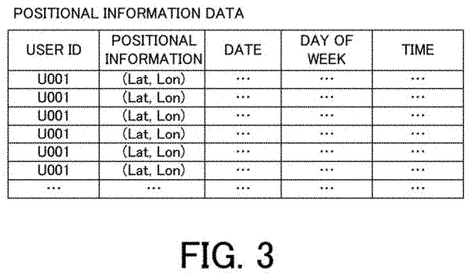

In addition, the storage unit 102 stores positional information which is periodically collected from the user terminal 200, as positional information data 102A. FIG. 3 is an example of the positional information data. As illustrated, the positional information data includes information such as a user's identifier (user ID), positional information (latitude and longitude), date, day of week, and time.

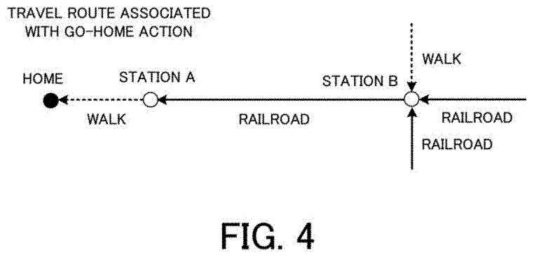

In addition, the storage unit 102 stores an action model for each user (action model 102B). The action model refers to a model that defines, with a travel route, an action which can be done by a user. FIG. 4 is a diagram for describing a travel route corresponding to the action of “going home.” In a case of the illustrated example, a station nearest to a home of a user is station A and the station A is connected to station B by a railroad line. In this case, when a travel route of the user matches with the pattern of “traveling from the station B toward the station A,” it can be estimated that the user is going home. In this embodiment, the action model thus stores information for determining that the user is doing the action of “going home” (go-home action). The action model corresponding to the user is stored in the storage unit 102 in advance. The action model may be generated based on information about a commuter pass held by the user or may be generated by machine learning.

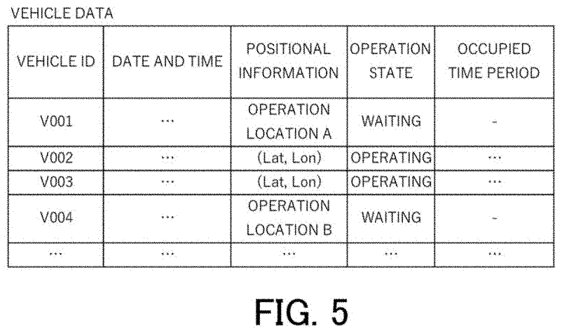

The storage unit 102 stores data for managing the plurality of vehicles 300 (vehicle data 102C). FIG. 5 is an example of the vehicle data. In the vehicle data, an identifier of each of the vehicles 300 which are managed by the system, and the positional information, operation state, occupied time period, or the like thereof are described. The vehicle data may include other information. For example, it may include: information about the usage and type of the vehicle 300, or a waiting place (garage or service office); and information about a car body size, carrying capacity (seating capacity), an allowable travel distance in a fully charged state, an allowable travel distance at a current time, a passing point, a travel route, a destination, or the like.

The vehicle data 102C is periodically updated based on the information transmitted from the vehicle 300 (hereinafter, vehicle information).

The communication unit 103 is a communication interface for connecting the server device 100 to a network. The communication unit 103 is configured to include, for example, a network interface board and a wireless communication circuit for wireless communication.

The configuration illustrated in FIG. 2 is one example and the whole or part of the illustrated functions may be executed by using an exclusively designed circuit. Furthermore, the storage or execution of a program may be performed by a combination of main memory and auxiliary memory, other than the one illustrated.

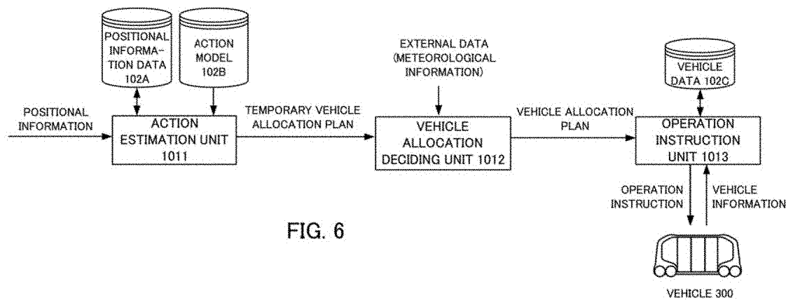

Next, processing performed by the control unit 101 will be described with reference to FIG. 6 that illustrates data transmitted and received between the modules.

The action estimation unit 1011 receives positional information from the user terminal 200 and accumulates the received positional information in the storage unit 102 as the positional information data 102A. In addition, the action estimation unit 1011 compares the accumulated positional information with the action model stored in the storage unit 102, thereby estimating that the user has started going home. For example, when changes in the positional information match with the travel route defined in the action model, it can be estimated that the user has started going home.

When the action estimation unit 1011 determines that the user has started going home, it decides a plan for allocating the vehicle 300. The vehicle allocation plan includes a location and time at which the vehicle 300 picks up the user.

For example, in a case of FIG. 4, when a riding time from the station B to the station A is 30 minutes, a vehicle allocation plan can be created so as to pick up the user at the station A 30 minutes after a train leaves the station B. The vehicle allocation plan generated by the action estimation unit 1011 is temporary one. The temporary vehicle allocation plan is transmitted to the vehicle allocation deciding unit 1012.

The vehicle allocation deciding unit 1012 decides whether to dispatch a vehicle according to the received vehicle allocation plan, based on external data. In the first embodiment, the vehicle allocation deciding unit 1012 obtains meteorological information from the external device 400 and decides, when a bad weather at the time of arrival of the user is predicted, to dispatch a vehicle according to the vehicle allocation plan. When the vehicle allocation deciding unit 1012 decides to dispatch a vehicle, a definitive vehicle allocation plan is transmitted to the operation instruction unit 1013.

The operation instruction unit 1013 performs processing of managing the plurality of vehicles 300 (first processing) and processing of deciding a vehicle 300 to be dispatched to the user and instructing the vehicle to operate (second processing).

The first processing is processing of periodically communicating with the plurality of vehicles 300, collecting information about the state of each vehicle (vehicle information), and updating the vehicle data 102C.

In addition, the second processing is processing of, on the basis of the received vehicle allocation plan, deciding a vehicle 300 to be dispatched to the user and transmitting an operation instruction to the vehicle 300. The vehicle 300 to be dispatched to the user can be decided based on the vehicle data 102C.

The vehicle 300 that has received an operation instruction travels according to the operation instruction so as to transport the user. The operation instruction may include information for specifying a location where the user gets off (for example, user's home).

According to the configuration described above, a vehicle for transporting a user can be arranged according to the action plan of the user.

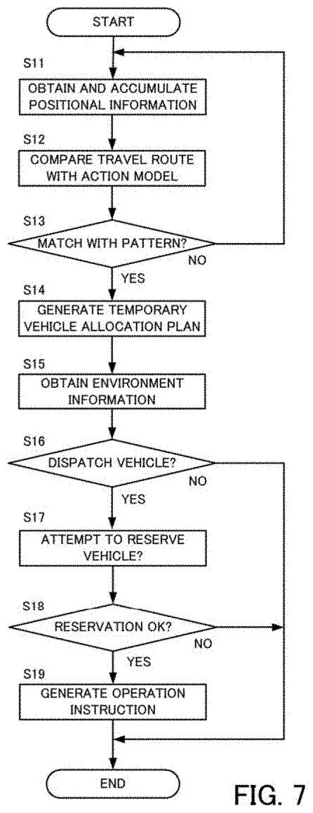

FIG. 7 is a flowchart of processing performed by the server device 100. The illustrated processing is periodically executed while the server device 100 is running. It should be noted that the above-described first processing (processing of the operation instruction unit 1013 collecting vehicle information and updating the vehicle data 102C) is executed in parallel with and independently of the illustrated processing.

At step S11, the action estimation unit 1011 receives positional information from the user terminal 200 and accumulates it in the storage unit 102.

Next, at step S12, a collection of the accumulated positional information and an action model corresponding to the user are compared with each other and it is determined whether travel matching with a travel route specified for the action model (a route corresponding to the go-home action) is being performed (step S13). For example, when a degree of matching between a positional transition and the travel route exceeds a threshold value, it can be determined that both are matched with each other. It both are matched with each other, the processing transitions to step S14.

At step S14, the action estimation unit 1011 generates a temporary vehicle allocation plan. For example, if information about a station nearest to a home of the user is included in the action model, the plan is generated so as to pick up the user at the nearest station and travel to the home of the user. The plan is transmitted to the vehicle allocation deciding unit 1012.

At step S15, the vehicle allocation deciding unit 1012 obtains environment information from the external device 400.

At step S16, the vehicle allocation deciding unit 1012 determines whether to dispatch the vehicle 300 to the user, based on the obtained information. For example, when the external device 400 is a device that provides meteorological information, in which a condition such as “it will rain,” “it will snow (snow will accumulate),” “temperature will exceed a predetermined value,” “discomfort index will exceed a predetermined value,” or the like is satisfied, the vehicle allocation deciding unit decides to dispatch the vehicle 300. In short, it decides to dispatch a vehicle 300 when there is a travel environment where it is preferable to pick up the user.

If the condition is satisfied, an operation plan is finalized and the processing transitions to step S17. The finalized operation plan is transmitted to the operation instruction unit 1013.

At step S17, the operation instruction unit 1013 attempts to reserve a vehicle 300 to be dispatched to the user. More specifically, an available vehicle 300 is extracted from the stored vehicle data 102C based on a time period for using a vehicle 300 and a travel route. If a vehicle 300 has been reserved (step S18: YES), the processing transitions to step S19. If a vehicle 300 has not been reserved (step S18: NO), the processing ends.

At step S19, the operation instruction unit 1013 generates an operation instruction for the reserved vehicle 300. The operation instruction includes a location where the user is picked up, an arrival time at the location, a location where the user is dropped off, an operation route, and the like. The generated operation instruction is transmitted to the vehicle 300. It should be noted that before the operation instruction is transmitted to the vehicle 300, a notification or confirmation that arrangements for the vehicle will be made may be transmitted to the user terminal 200. In doing so, a reason that the server device 100 has determined to dispatch the vehicle 300 (for example, a bad weather is predicted) may be transmitted at the same time.

As described above, the server device 100 according to the first embodiment estimates that the vehicle 300 will become necessary for the user based on positional information received from the user terminal 200 and environment information indicating a travel environment of the user; and autonomously makes arrangements for the vehicle. This configuration allows a vehicle to be arranged without waiting for a user's request, thereby improving convenience of the user.

In the first embodiment, whether to dispatch the vehicle 300 is decided only based on meteorological information; however, the propriety of dispatching the vehicle 300 may be decided by using other information. For example, information on the history of payments made by the user while going out may be received from the user terminal 200 and the amount of baggage being carried by the user may be determined by the information. When the amount of baggage being carried by the user is more than a predetermined amount, for example, it may be decided to dispatch the vehicle 300.

Alternatively, the amount of baggage may be determined based on a result of sensing the user. For example, the external device 400 may capture an image of a user who is going out, by a monitoring camera installed at a predetermined location and based on a result of analyzing the captured image, may determine the amount of baggage.

### Second Embodiment

The vehicle allocation system according to the first embodiment picks up a user at a predetermined location (a station nearest to a home of the user). On the other hand, in the second embodiment, it detects that travel of a user is interfered with due to some trouble, and dispatches a vehicle 300 so as to help the user.

In the second embodiment, both a device that provides meteorological information and a device that provides operation information of public transportation are used as external devices 400.

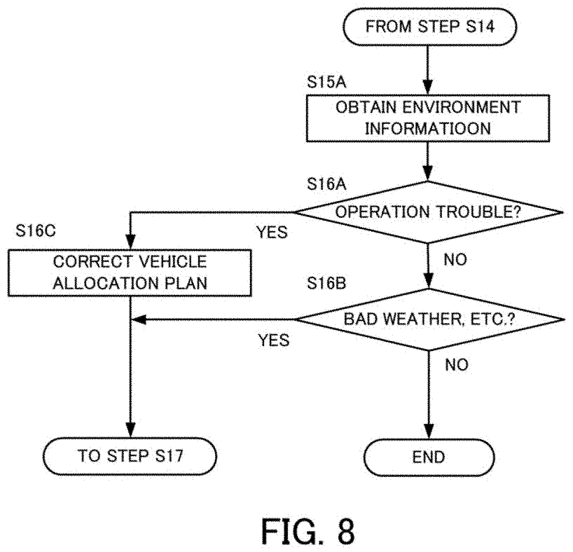

FIG. 8 is a partial flowchart that illustrates the processing of steps S15 and S16 out of processing executed by the server device 100 in the second embodiment. The other steps are the same as those of the first embodiment.

In the second embodiment, after a temporary vehicle allocation plan is generated at step S14, operation information of public transportation is obtained in addition to meteorological information at step S15A.

At step S16A, it is determined whether an operation trouble of public transportation has occurred on a travel route of the user, based on the obtained operation information. If an affirmative determination is made here, the processing transitions to step S16C, where the temporary vehicle allocation plan is modified. More specifically, a location where travel of the user is interfered with is reset as a vehicle allocation destination of the vehicle 300.

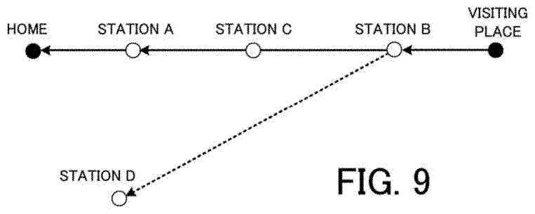

Explanation will be provided with reference to FIG. 9.

For example, when the operation of a railroad connecting between a station A and a station B has been interrupted (or a significant delay has occurred) while the user is traveling along an illustrated travel route (solid line), it can be determined that the travel of the user has been interfered with at the station B. For example, if the vehicle allocation location decided at step S14 is the station A, this is modified to the station B.

In addition, when it is found that the operation of a train which the user is riding will be interrupted at the station C, the vehicle allocation location may be changed from the station A to the station C.

Furthermore, when the user is heading for the station D by train for detouring, the vehicle allocation location may be changed from the station A to the station D. As described above, in a case where the user is likely to take a detour at the time of occurrence of a trouble in the operation of public transportation, information about a route for the detour may be included in an action model.

A time at which the vehicle 300 is to be dispatched can be decided according to a user's action. For example, when the user has already arrived at the station B, the vehicle 300 may be immediately sent to the station B. In addition, when the operation of a train on which the user is riding is interrupted at the station C, the vehicle 300 may be sent to the station C in time for a time at which the train will arrive at the station C. In addition, when the user is riding on a train for detouring, the vehicle 300 may be sent to the station D in time for a time at which the train will arrive.

If a negative determination is made at step S16A, the processing transitions to step S16B, where arrangements for the vehicle 300 are made according to a reference similar to that in the first embodiment (for example, whether a bad weather is predicted). If a positive determination is made at step S16B, the temporary vehicle allocation plan is finalized.

If a negative determination is made at both step S16A and S16B, arrangements for a vehicle are not made.

According to the second embodiment, it is possible to predict a location where travel of a user will become difficult and to make a vehicle 300 operate so as to help the user.

In this embodiment, the operation information of public transportation is used; however, other information may be used to predict that the travel of the user will become difficult and where (when) it will occur.

In addition, in this embodiment, an operation trouble on a railroad is used as an example; however, a vehicle 300 may be arranged in a case where it is predicted that the operation of public transportation will end while the user is traveling.

### Third Embodiment

In the first and second embodiments, a single action model corresponding to the action of “going home” is used as an example; however, a plurality of action models for one user may be stored. For example, a plurality of action models such as a “go-home model for weekdays” and a “go-home model for holidays” may be stored and by using the plurality of action models, the go-home action of the user may be determined.

In addition, an action to be detected is not limited to a go-home action. For example, actions such as “going to work” and “going to school” may be detection targets. In the first embodiment, the user who travels from its nearest station to its home is transported by the vehicle 300; however, for example, transport in a freely selected section such as “from a station nearest to a workplace to the workplace” may be performed according to the type of a detected action.

### Fourth Embodiment

In addition, in the first and second embodiments, an action model corresponding to a single user is stored in the server device 100; however, action models of a plurality of persons may be stored in the storage unit 102 and an action of each of the plurality of users may be estimated.

For example, a user terminal 200 may transmit data for identifying an individual to the server device 100 together with positional information; and the action estimation unit 1011 may estimate an action by using an action model of a corresponding user.

(Modification)

The above embodiments are merely examples, and the present disclosure may be appropriately modified and implemented without departing from the spirit thereof.

For example, the processing and units described in the present disclosure can be implemented by being freely combined as long as a technical contradiction does not occur.

In addition, in the description of the embodiments, a mode of receiving positional information from the user terminal 200 is illustrated; however, the position of the user may be obtained by other methods. For example, a current position of the user may be determined by passing information of a traffic IC card. In addition, when a plurality of sensors (such as cameras) that can identify the user are installed all over town, a current position of the user may be determined based on outputs of the sensors.

In addition, in the description of the embodiments, a mode of determining an action which is currently being done by the user is illustrated; however, an action which can be done by the user later may be predicted. For example, if it is determined, based on data obtained by sensing the user, that the user will start a predetermined action (for example, a go-home action) before long, processing at and after step S14 may be started.

In addition, the processing described as being performed by one device may be shared and executed by a plurality of devices. Alternatively, the processing described as being performed by different devices may be executed by one device. In a computer system, what hardware configuration (server configuration) realizes each function can be flexibly changed.

The present disclosure can also be realized by supplying a computer program including the functions described in the above embodiments to a computer and causing one or more processors included in the computer to read and execute the program. Such a computer program may be provided to the computer by a non-transitory computer-readable storage medium connectable to a system bus of the computer, or may be provided to the computer via a network. Examples of non-transitory computer readable storage media include: any type of disk such as a magnetic disk (floppy (registered trademark) disk, hard disk drive (HDD), etc.), an optical disk (CD-ROM, DVD disk, Blu-ray disk, etc.); and a read-only memory (ROM), a random access memory (RAM), EPROM, EEPROM, a magnetic card, flash memory, an optical card, or any type of medium suitable for storing electronic instructions.

What is claimed is:

1. An information processing device, comprising:
a controller configured to execute:
estimating an action being done by a user, based on first data about the action of the user;
obtaining second data about a travel environment of the user; and
deciding whether to dispatch a vehicle to the user, based on the estimated action and the second data.

2. The information processing device according to claim 1, wherein
the first data includes positional information corresponding to the user.

3. The information processing device according to claim 2, wherein
the controller estimates the action being done by the user, based on changes in the positional information, the positional information being periodically obtained.

4. The information processing device according to claim 1, wherein
the controller periodically obtains vehicle information, the vehicle information being information about the vehicle, and further determines whether the vehicle can be dispatched, based on the vehicle information.

5. The information processing device according to claim 1, wherein
when it is estimated that the user is doing a go-home action, the controller estimates based on the first data, a first time at which the user is to arrive at a station nearest to a home of the user.

6. The information processing device according to claim 5, wherein
the controller causes the vehicle to arrive at the nearest station by the first time.

7. The information processing device according to claim 1, wherein
the second data is data about weather.

8. The information processing device according to claim 1, wherein
the second data is data about an amount of baggage associated with the user.

9. The information processing device according to claim 1, wherein
the controller estimates a location where travel of the user becomes difficult, based on the second data; and dispatches the vehicle to the location.

10. The information processing device according to claim 9, wherein
the second data is data about operation of public transportation.

11. The information processing device according to claim 1, further comprising:
a storage configured to store data representing a typical action pattern taken by the user;
wherein the controller estimates the action based on a result of comparison between the first data and the action pattern.

12. The information processing device according to claim 1, further comprising:
a storage configured to store data representing a typical action pattern taken by each of a plurality of the users;
wherein the controller estimates the action of any of the plurality of users based on a result of comparison between the first data and the action patterns of the plurality of users.

13. An information processing system, comprising:
a first device held by a user; and
a second device associated with a vehicle; wherein
the first device includes a first controller configured to transmit first data to the second device, the first data being about an action of the user; and
the second device includes a second controller configured to execute:
estimating an action being done by the user, based on the first data;
obtaining second data about a travel environment of the user; and
deciding whether to dispatch the vehicle to the user, based on the estimated action and the second data.

14. The information processing system according to claim 13, wherein
the first data is positional information obtained by the first device.

15. The information processing system according to claim 14, wherein
the second controller estimates the action being done by the user, based on changes in the positional information, the positional information being periodically obtained.

16. The information processing system according to claim 13, wherein
the second controller periodically obtains vehicle information, the vehicle information being information about the vehicle, and further determines whether the vehicle can be dispatched, based on the vehicle information.

17. The information processing system according to claim 13, wherein
when it is estimated that the user is doing a go-home action, the second controller estimates based on the first data, a first time at which the user is to arrive at a station nearest to a home of the user.

18. The information processing system according to claim 17, wherein
the second controller causes the vehicle to arrive at the nearest station by the first time.

19. The information processing system according to claim 13, wherein
the second data is data about weather or data about operation of public transportation.

20. A non-transitory computer readable storing medium recording a computer program for causing a computer to perform an information processing method comprising:
estimating an action being done by a user, based on first data about the action of the user;
obtaining second data about a travel environment of the user; and
deciding whether to dispatch a vehicle to the user, based on the estimated action and the second data.
